(19) United States
(12) Patent Application Publication
(10) Pub. No.: US 2008/0286632 A1
(43) Pub. Date: Nov. 20, 2008

(54) Membrane Electrode Assemblies for Polymer Electrolyte Hydrogen and Direct Methanol Fuel Cells and Methods for Their Production

(76) Inventors: Madeleine Odgaard, Odense M (DK); Peter Lund, Ringe (DK); Steen Yde-Andersen, Svendborg (DK)

Correspondence Address: LICATA & TYRRELL P.C., 66 E. MAIN STREET, MARLTON, NJ, 08053, US

(21) Appl. No.: 12/091,085

(22) PCT Filed: Oct. 26, 2006
(86) PCT No.: PCT/EP06/10338

§ 371 Date: Apr. 22, 2008

Related U.S. Application Data
(60) Provisional application No. 60/730,904, filed on Oct. 27, 2005.

(51) Int. Cl. H01M 4/86; B05D 5/12; H01M 4/88

(52) U.S. Cl. 429/40; 502/101; 427/115

(57) ABSTRACT

Membrane Electrode Assemblies for Polymer Electrolyte Hydrogen and Direct Methanol Fuel Cells and Methods for Their Production Electrodes and membrane electrode assemblies for use in fuel cells are provided containing a plurality of layers of catalyst and binder, wherein the first layer (2a, 2b) adjacent to the PEM (1) of the plurality of layers (3a, 3b, 4a, 4b, 5a, 5b) contains a higher concentration of catalyst as compared to each subsequent layer of the electrode.

This patent application claims the benefit of priority from U.S. Provisional Application Ser. No. 60/730,904, filed Oct. 27, 2005, teachings of which are herein incorporated by reference in their entirety.

### FIELD OF THE INVENTION

The present invention relates to membrane electrode assemblies (MEA) for direct methanol and hydrogen fuel cells. In particular, the invention relates to the electrodes used in polymer electrolyte fuel cells, and to the improvements of the electrodes, by optimization of the distribution of the electroactive catalysts in the electrodes.

### BACKGROUND OF THE INVENTION

Fuel cells are devices used for direct conversion of chemical energy in the form of, for example hydrogen or methanol, to electrical energy. The fundamental electrochemical reaction of fuel cells, namely conversion of hydrogen and oxygen, is similar in all fuel cell systems. Thus, fuel cells are usually distinguished from each other by the electrolyte used.

Several different electrolyte systems based on, for example, liquid and solid acids and bases are available. Compared to other fuel cell systems, acidic solid polymer electrolyte fuel cells offer advantages such as greater power densities, lower operating temperature, and longer operating lifetimes and are generally more resistant to corrosion. They are easy to incorporate into fuel cell structures and several configurations and preparation methods have been devised. See e.g. U.S. Pat. No. 4,469,579; U.S. Pat. No. 4,826,554; U.S. Pat. No. 5,211,984; U.S. Pat. No. 5,272,017; U.S. Pat. No. 5,316,871; U.S. Pat. No. 5,399,184; U.S. Pat. No. 5,472,799; U.S. Pat. No. 5,474,857; and U.S. Pat. No. 5,702,755.

The general principles of fuel cells are described in G. Hoogers (ed.), “Fuel Cell Technology Handbook” published by CRC Press, NY 2003. The smallest complete fuel cell consists of a polymer electrolyte membrane (PEM) separating an anode from a cathode and is commonly referred to as the membrane electrode assembly (MEA). Each electrode in the MEA is backed by a gas diffusion layer, which assists in dispersing the reactant gases and in collecting the electrons formed or consumed by the electrochemical reactions.

The electrochemical reactions producing the electrical energy are:

Anode:

H₂=>2H⁺+2e⁻ (E_{anode}=0 V)

Cathode:

½O₂+2H⁺+2e⁻=>H₂O (E_{cathode}=1.23 V)

which correspond to the cell reaction:

H₂+½O₂=>H₂O (E_{cell}=1.23 V)

The porous electrodes allow gas to diffuse into the electrodes to the electrochemically active sites and contain a catalyst such as finely dispersed platinum metal or platinum metal supported on carbon particles, which facilitate the electrochemical reaction.

On the anode side the hydrogen is oxidized to hydrogen ions, which migrate through the electrolyte membrane to the cathode side. The electrons are conducted from the anode through the gas diffusion layer to the external electric circuit and enter the fuel cell though the gas diffusion layer on the cathode where oxygen is reduced to water. PEM fuel cells utilize hydrogen as the fuel. Hydrogen is converted directly to electrical energy by the above reactions.

The MEA of the direct methanol fuel cells (DMFC) contain similar building blocks to the hydrogen fuel cell, but convert methanol to hydrogen ions and carbon dioxide internally through the reaction:

### Anode:

CH₃OH+H₂O=>CO₂+6H⁺+6e⁻ (E_{anode}=0.046 V)

The hydrogen ions are conducted from the anode through the polymer electrolyte and the electrons through the external electric circuit, to the cathode, and reduce oxygen to water according to:

### Cathode:

3/2O₂+6H⁺+6e⁻=>3H₂O (E_{cathode}=1.23 V)

The complete electrochemical reaction is:

CH₃OH+ 3/2O₂+H₂O=>CO₂+3H₂O (E_{cell}=1.18 V)

which indicates that the fuel cell relies on the presence of liquid water to conduct the protons efficiently. Thus, compared to the hydrogen fuel cell, a penalty is paid since the cell voltage is lower at a given load. This reduces the voltage, and hence the conversion efficiency, compared to the hydrogen fuel cell. However, the advantages of transporting a liquid fuel rather than a gas, makes the DMFC an attractive alternative.

Both fuel cells utilize identical acidic proton conducting polymer electrolytes such as Nafion, Flemion, or Aciplex-S. Although some dissimilarities exist between the two fuel cell systems, the electrodes in both systems are very similar in content and manufacturing process, and the concept with which the present invention is concerned, is thus applicable to both types of fuel cells and their respective electrodes.

The electrodes consist of a binder, usually identical to the polymer used as the electrode separator, and a catalyst which promotes the electrochemical reactions. The electrodes may also contain high surface area, electronically conducting carbon powder. Commonly used catalysts are platinum or alloys of platinum metals in the form of high surface area metal powders or metals or alloys distributed on the surface of carbon particles. The latter solution is often used to reduce the amount of expensive metal.

The need for an electrochemically active catalyst, and ways to incorporate the catalysts into the electrodes, are described in detail in G. Hoogers (ed.), “Fuel Cell Technology Handbook” published by CRC Press, NY 2003. A high power density and a high conversion efficiency depend to a large extent on the nature of the catalysts used, on the amounts of catalyst used in the electrodes, and on the construction of the electrodes and the MEA. The theoretical voltage of a cathode is 1.23 V, but this is usually not reached due to performance losses associated with cell components and electrochemical processes. The voltage at a given current density is reduced by a number of different factors, of which the most important are the primary electrochemical reactions on the anode and cathode. The voltage depression (referred to as overvoltage in the following) caused by these reactions is to a large extent determined by the use of the electrochemically active catalysts in the two electrodes. Both the nature of the catalysts and the amounts used in the electrodes plays a role.

It is generally accepted that a higher catalyst loading, particularly in the cathode, allows higher current densities to be attained. This is however, not a viable route to higher current densities since only expensive platinum and similar metals are efficient catalysts for the reaction. As the catalyst loading increases, the utilization of the catalyst decreases. Doubling the catalyst amount, will not necessarily double the utilization. Apart from using metal catalysts supported on carbon to save material and utilize the catalyst more efficiently, the most rewarding approach to efficient fuel cell technology is the design of the electrodes and the MEA.

Electrodes are commonly produced by preparation of a slurry consisting of the catalyst and/or carbon dispersed in a solution of the binder polymer. Effective binder systems contain an ionically conducting polymer such as those used in the polymer electrolyte membrane (e.g. Nafion). The binder is dissolved in a suitable solvent such as water/alcohol mixtures. The components are thoroughly mixed with each other e.g. in a ball-mill, high speed mixer or similar device.

MEA preparation is commonly approached from one of two directions. In one embodiment, the catalyst layer is applied directly onto both sides of the polymer electrolyte surface by a silk screen printing technique. Alternatively, the catalyst layer is silk screen printed onto a non-adhering surface such as a Teflon foil. The electrodes are then subsequently transferred to the polymer electrolyte surface by heat pressing. In another embodiment, the electrodes are printed onto the gas diffusion layer (GDL) and then subsequently heat laminated with the polymer electrolyte membrane. Other application methods such as painting, coating, and spraying have also been used.

Another approach has been disclosed in U.S. Pat. No. 6,258,239, wherein the catalyst is prepared electrochemically in the electrodes by an electrolysis reaction.

In each of these processes, a predetermined amount of catalyst is evenly and uniformly distributed throughout each of the electrodes. Typically, a single catalyst layer is applied, or the catalyst layer is constructed by application of several layers of the same material. For example, if preparation of the catalyst layer involves silk screen printing, the layer may be applied in the desired thickness in a single printing or by printing several layers consecutively on top of each other. Thus, a 50 μm thick layer may be printed as a single layer or by application of, for example, two times a 25 μm thick layer. More than two printings may likewise be necessary to obtain the desired properties of the catalyst layer.

By controlling, not only the nature and amount of catalyst, but also the distribution of the catalyst throughout the two electrodes, it has now been found to be possible to increase the conversion and power efficiency, as well as reduce the over-voltage associated with the electrochemical conversion of chemical fuel to electrical energy.

### SUMMARY OF THE INVENTION

The present invention provides improved methods for design and construction of electrodes and membrane electrode assemblies (MEA) used in fuel cells. In the present invention, the construction of the catalyst layer differs from commonly used designs in that the electrodes are made by sequentially applying multiple layers of electrode material of different compositions on top of each other. That is, the catalyst layer is prepared, for example by silk screen printing multiple layers of electrode material on top of each other wherein the layers differ from each other in catalyst loading and/or thickness. In a preferred embodiment, catalyst loading is highest in layers close to the polymer electrolyte membrane, and decreases towards the gas diffusion layer (GDL). Fuels cells with electrodes and/or MEAs prepared in accordance with this design exhibit reduced over-voltage and a higher conversion and power efficiency as compared fuel cells comprising identical components in identical overall amounts, having similar porosities, but which have a uniform distribution of the same average amount of catalyst in the electrodes.

### BRIEF DESCRIPTION OF THE DRAWINGS

FIG. 1 provides a diagram of an MEA of the present invention with its multi-layered electrode structure.

FIG. 2 provides a comparison of the voltage and power as a function of the applied current of a fuel cell produced in accordance with the present invention and a fuel cell based on conventional cathodes and anodes.

### DETAILED DESCRIPTION OF THE INVENTION

The present invention provides electrodes and membrane electrode assemblies (MEAs) with a reduced over-voltage, and an improved conversion and power efficiency compared to commonly used electrodes and MEA structures.

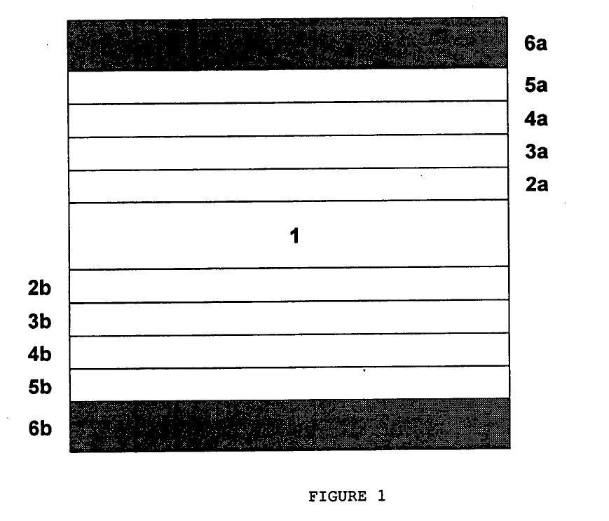

An exemplary MEA of the present invention sandwiched between gas diffusion layers (GDLs) is shown schematically in FIG. 1.

As shown in FIG. 1, the entire MEA construction comprises a polymer electrolyte membrane (PEM) 1 sandwiched between composite electrodes 7 and 8, each electrode comprising multiple layers of binder, usually identical to the polymer used in the PEM, an electrochemically active catalyst and, in some embodiments, conducting carbon.

Examples of membrane materials used in the present invention include but are not limited to Nafion (DuPont), Flemion (Asahi Glass Company), Aciplex-S (Asahi Chemical) and Gore-Select (W. L. Gore).

The catalyst may either be pure metal in the form of, for example, Pt Black (E-Tek, Fuel cell Grade Pt Black), or bimetallic such as Pt/Ru Black (Johnson Mattey, HiSpec 6000).

In some embodiments, the catalyst is dispersed on the surface of a carbon, for example carbon supported Pt/Ru alloy (Johnson Mattey, HiSpec 10000). Similar products are available from companies including, but not limited to, Engelhard and E-Tek. The carbon types used are often Vulcan XC72 from Cabot and Shawinigan Black from Chevron.

As shown in FIG. 1, the PEM 1 is sandwiched between an anode electrode 7 and a cathode electrode 8. The two electrodes are constructed from several layers each consisting of from 0 w/o to 100 w/o carbon, and from 100 w/o to 0 w/o catalyst material, calculated with respect to each other.

The layer closest to the membrane, referred to herein as the first layer and depicted in the anode electrode as 2a and in the cathode electrode as 2c, contains the highest amount of catalyst material. In some embodiments, this first layer 2a, 2c consists of pure catalyst and binder. The next layer, referred to herein as the second layer and depicted in the anode electrode as 3a and in the cathode electrode as 3c, comprises a lower amount of catalyst as compared to the first layer. This can be achieved by use of a carbon supported catalyst and/or by increasing the amount of binder in the electrode as compared to that used in the first layer. Continuing to the third and fourth layers, 4a and 5a of the anode electrode and 4c and 5c of the cathode electrode, the amount of catalyst is further reduced, and may gradually reach 0 w/o catalyst, i.e. the fourth layers 5a and 5c may consist only of binder and carbon. Thus, as a nonlimiting example, a layered anode or cathode electrode of the present invention may comprise a first layer with 100 w/o catalyst, a second layer with 66 w/o catalyst, a third layer with 33 w/o catalyst and a fourth layer with 0 w/o catalyst.

Further, as will be understood by those skilled in the art upon reading this disclosure, FIG. 1 provides one example of a layered MEA of the present invention. The number of layers as well as the composition of each layer can be altered to provide the most efficient use of the materials and will be dependent on the choice of binder, catalyst and carbon used in the electrode. In addition, the layered anode electrode 7 and the layered cathode electrode 8 used in an MEA may differ in the number of layers, the choice of binder, catalyst and carbon and the amount of catalyst used in the layers. For example, it may be more efficient to use platinum containing catalysts in the cathodes whereas a higher efficiency is possible by use of a bimetallic catalyst such as, but not limited to, platinum/ruthenium in the anode.

As further depicted in FIG. 1, the cathode/PEM/anode stack is capped by GDLs 6a and 6c, which are electronically conducting and porous.

Each layer of the electrodes is prepared by application of a homogeneous ink consisting of a mixture of binder, catalyst and if necessary a conducting carbon. The binder is dissolved in water or a mixture of water and alcohols, and the dispersions are mixed thoroughly. Examples of mixing devices useful in the present invention include, but are not limited to, high speed mixers, sandmills and other similar devices. The electrodes are prepared by application directly onto the PEM or the GDLs. Examples of application methods include, but are not limited to, serigraphical printing, painting, coating, spraying and other suitable methods.

The MEA consisting of the polymer electrolyte membrane, sandwiched between the anode electrode and cathode electrode and GDLs, is simultaneously bonded together in a solid structure by compression in a constraint that prevents volume and lateral deformation of the materials. In a preferred embodiment, heat compression is used at a temperature between 120° C. and 180° C., preferably in the range 135° C. to 170° C., and more preferably at 140° C. and a surface pressure of 10 to 150 bar, preferably in the range 10 to 40 bar, and more preferably 20 bar.

Membrane electrode assemblies prepared according to this invention, have been shown to be up to about 50% more efficient in terms of reduced overvoltage and increased power, compared to MEAs of identical average composition but in which the materials in each electrode are distributed evenly and homogeneously through the electrodes. It has especially been observed that fuel cells with these MEAs exhibit higher cell voltage at the same current density, compared to fuel cells based on conventional MEAs.

A person skilled in the art, will recognize upon reading this disclosure that the present invention may find use in other types of fuel cells and that many modifications are possible in the embodiments described above, without departing from the teachings thereof. For example, the anodes and cathodes for hydrogen and methanol based fuel cells are very similar to each other. Identical materials are used, and the production methods of electrodes and MEAs are identical as well. Thus, it is expected that the electrodes of the present invention will be useful in these fuel cells as well.

The following nonlimiting example shows the improved performance of a fuel cell prepared in accordance with the present invention as compared to a conventional fuel cell.

### EXAMPLE

For this comparison, a conventionally prepared fuel cell and a fuel cell of the present invention prepared as described in detail below were tested under identical conditions. The conventional fuel cell comprised uniform electrodes, prepared by identical methods, and with compositions corresponding to the average composition of the electrodes used in the MEA of the present invention. No further details in the preparation of the conventional MEA are considered to be necessary for the comparison of the two fuel cells.

The compositions of the dry two layer electrodes used in the convention fuel cell are given in the table below:

| | Anode | | Cathode | |
|---|---|---|---|---|
| | Binder | Catalyst/C | Binder | Catalyst/C |
| Layer 1 | 7.5 w/o | 92.5 w/o | 25 w/o | 75 w/o |
| | Nafion | Pt/Ru | Nafion | Pt black |
| | | black | | |
| Layer 2 | 7.5 w/o | 92.5 w/o | 25 w/o | 75 w/o |
| | Nafion | Pt/Ru | Nafion | Pt black |
| | | black | | Carbon |
| | | Carbon | | supported |
| | | supported | | |

Both the carbon supported catalysts contain 60 w/o metal phase. Nafion was obtained from Dupont, and the catalysts used were HiSpec 6000 Pt/Ru Black, HiSpec 10000 Pt/Ru Black on carbon support, HiSpec 9000 Pt Black on carbon support, all from Johnson Mattey, and Fuel Cell Grade Pt Black from E-Tek. Additionally, for the conventional electrodes, Vulcan XC-72 carbon black from Cabot was used to adjust the composition of the electrodes to match the average compositions of the electrodes of the present invention.

To prepare a fuel cell with electrodes of the present invention, electrode slurries were first made by dispersing the catalyst powders, and carbon powders where necessary, in a solution of Nafion in solvent mixture of 50 w/o water and 50 w/o 1,2-propandiol. Homogenization of both anode and cathode slurries were ensured by mixing the slurries with an Ultra Turrax high speed mixer for 10 minutes at 9000 RPM. The slurry compositions were:

| | Anode | Cathode |
|---|---|---|
| Layer 1 | 15 w/o solids | 15 w/o solids |
| Layer 2 | 45 w/o solids | 25 w/o solids |

Both anodes and cathodes were made by the following procedure:
First, an electrode layer was applied onto the GDL layer (Toray Carbon Paper TGPH-090 from E-Tek) by serigraphical silk screen printing followed by drying at 40° C. for 15 minutes in open air, followed by drying at 100° C. under vacuum for 20 minutes. The composition of this layer is identical to the composition denoted as layer 2 in the above table.

The layer denoted layer 1 in the table above was then applied on top of the dry layer 2, also by serigraphical silk screen printing, followed by an identical drying procedure.

The total catalyst loading of both anodes and cathodes was approximately 2 mg/cm².

Membrane electrode assemblies were subsequently formed by sandwiching a Nafion membrane between the resulting anode electrode and cathode electrode and hot pressing the assembly for 4 minutes at a temperature of 140° C. and a pressure of 20 kg/cm². The membrane was positioned adjacent to layer 1 on both electrodes; that is, adjacent to the part of each electrode having the highest catalyst loading.

Fuel cells containing both a conventional MEA and a MEA of the present invention, were tested at 70° C. The fuel supplied to the anode, was 1 M CH₃OH in water at a stoichiometric ratio of λ_{CH3OH}=6, and the fuel to the cathode was air at a stoichiometric ratio of λₐᵢᵣ=4.

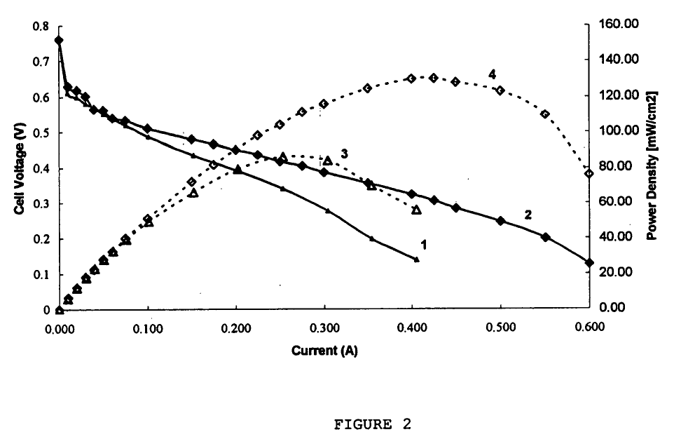

FIG. 2 shows a comparison of the voltage traces and the power traces as a function of the applied load, for the conventional fuel cell (voltage trace 1, power trace 3) and the fuel cell of the present invention (voltage trace 2, power trace 4). Whereas no significant differences are observed in either the voltage or the power, at currents below approximately 0.1 A, it is clear that, in both cases the voltage depression is increasing as the current is increased. However, the voltage depression is significantly more pronounced for the fuel cell based on the conventional electrodes. For example, at a current of 0.4 A, the voltage of the fuel cell comprising the conventional electrodes has decreased to approximately 0.12 V, and at the same current, the voltage of the fuel cell with the newly invented electrodes is at approximately 0.3 V. As a result, a peak power of about 130 mW/cm² is attainable at approximately 0.4 A with the new electrodes, as compared to a peak power of only about 85 mW/cm² at a current of approximately 0.28 A using the old electrodes. Thus, a fuel cell based on the electrodes of the present invention is able to deliver a significantly higher power, due to the reduced voltage depression.

1. An electrode for use in a fuel cell, said electrode comprising a plurality of layers containing a catalyst and a binder, wherein a first layer of the plurality of layers contains a higher concentration of catalyst as compared to each subsequent layer of the electrode.

2. A membrane electrode assembly for use in a fuel cell comprising a polymeric electrode membrane sandwiched between an anode electrode and a cathode electrode, wherein said anode electrode and said cathode electrode each comprise a plurality of layers containing a catalyst and a binder, wherein a first layer of the plurality of layers adjacent to the polymeric electrode membrane contains a higher concentration of catalyst as compared to each subsequent layer of said anode electrode and said cathode electrode.

3. The membrane electrode assembly of claim 2 further comprising a gas diffusion layer adjacent to the anode electrode and a gas diffusion layer adjacent to the cathode electrode.

4. A method for preparing a membrane electrode assembly for use in a fuel cell comprising:
(a) applying to a first side of a polymer membrane electrode an anode electrode comprising a plurality of layers containing a catalyst and a binder, wherein a first layer of the plurality of layers applied to the polymeric electrode membrane contains a higher concentration of catalyst as compared to each subsequent layer; and
(b) applying to the opposite side of a polymer membrane electrode a cathode electrode comprising a plurality of layers containing a catalyst and a binder, wherein a first layer of the plurality of layers applied to the polymeric electrode membrane contains a higher concentration of catalyst as compared to each subsequent layer.

5. The method of claim 4 wherein the plurality of layers of the anode and cathode electrodes are serigraphically printed onto the polymeric membrane electrode.
